(19) United States
(12) Patent Application Publication
(10) Pub. No.: US 2026/0015203 A1
(43) Pub. Date: Jan. 15, 2026

(54) ELEVATOR BRAKE

(71) Applicant: Otis Elevator Company, Farmington, CT (US)

(72) Inventor: Juan Antonio Illan, Las Rozas (ES)

(21) Appl. No.: 19/259,483

(22) Filed: Jul. 3, 2025

(30) Foreign Application Priority Data
Jul. 15, 2024 (EP) 24382764.9

(51) Int. Cl. B66B 1/36; B66B 5/02

(52) U.S. Cl. CPC B66B 1/365; B66B 5/02

(57) ABSTRACT

An elevator brake for braking rotation of a shaft in an elevator drive system comprises at least two brake discs mounted to the shaft Such as to rotate concurrently with the shaft; at least three movable plungers, which are movable along the axial direction (A) for selectively engaging or releasing the elevator brake; and an actuator. The actuator comprises at least two springs configured for applying a spring force to at least one of the at least three movable plungers for urging the at least one movable plunger towards at least one of the brake discs for engaging the elevator brake; and at least two solenoids for producing a counterforce directed against the respective spring force applied by a respectively associated spring such as to urge the respective at least one movable plunger in the axial direction (A) away from the respective brake disc.

### FOREIGN PRIORITY

This application claims priority to European Patent Application No. 24382764.9, filed Jul. 15, 2024, and all the benefits accruing therefrom under 35 U.S.C. § 119, the contents of which in its entirety are herein incorporated by reference.

### TECHNICAL FIELD

The invention relates to an elevator brake. The invention further relates to an elevator drive system and to an elevator system comprising at least one elevator brake, respectively.

### BACKGROUND

An elevator system typically comprises at least one elevator car that is configured for moving along a hoistway extending between a plurality of landings and a drive system that is configured for driving the elevator car.

The drive system comprises at least one motor for moving the elevator car along the hoistway and at least one elevator brake for braking and stopping the movement of the elevator car.

The at least one elevator brake may comprise a brake disc and at least one plunger that is movable into frictional engagement with the brake disc for braking and stopping any rotation of the brake disc. In order to allow reliably braking and stopping movement of the elevator car even in case one of the plungers should not move due to a malfunction, a typical elevator brake comprises at least two plungers that are movable independently of each other. In order to enhance the reliability and safety of the elevator brake even further, the elevator brake may comprise two brake discs, with a first plunger acting onto a first brake disc and a second plunger acting onto a second brake disc, respectively. Providing an elevator brake with at least two brake discs and with at least two plungers may be required by elevator safety codes.

An elevator brake comprising two brake discs and two plungers may cause hard stops of the elevator car when both plungers are simultaneously moved into frictional engagement with the brake discs, for example in case of a loss of electric power.

It would therefore be beneficial to provide an improved elevator brake that allows preventing hard stops of the elevator car without deteriorating the safety of the elevator brake.

### SUMMARY

According to an exemplary embodiment of the invention, an elevator brake for braking rotation of a shaft extending along an axial direction in an elevator drive is provided. The shaft is rotatable around an axis of rotation extending along the axial direction, and the elevator brake comprises: at least two brake discs including a first brake disc and a second brake disc, at least three movable plungers and an actuator. The at least two brake discs are mounted to the shaft such as to rotate concurrently with the shaft. The at least three movable plungers include a first plunger, a second plunger and a third plunger. The at least three movable plungers are movable along the axial direction for selectively engaging or releasing the elevator brake. The actuator comprises at least two springs including a first spring and a second spring and at least two solenoids. Each of the at least two springs is configured for applying a spring force to at least two of the at least three movable plungers for urging the at least one movable plunger towards at least one of the brake discs for engaging the elevator brake. Each of the at least two solenoids is associated with a respective one of the at least two springs and configured for producing a counterforce directed against the respective spring force applied by the respectively associated spring such as to urge the respective at least one movable plunger in the axial direction away from the respective brake disc. The at least two springs are arranged in series to each other along the axial direction.

Exemplary embodiments of the invention also include an elevator drive system comprising a rotatable shaft extending in an axial direction, a motor configured for rotating the shaft, and an elevator brake according to an exemplary embodiment of the invention that is configured for braking and stopping rotation of the shaft.

Exemplary embodiments of the invention further include an elevator system comprising an elevator car that is movable in a hoistway between a plurality of landings and an elevator drive system according to an exemplary embodiment of the invention that is configured for moving the elevator car along the hoistway.

In an elevator brake according to an exemplary embodiment of the invention, the at least two brake discs and the at least two plungers provide the required redundancy for enhancing the safety of the elevator brake.

Since in an elevator brake according to an exemplary embodiment of the invention the at least two springs are arranged and coupled in a serial configuration along the axial direction, braking forces that are sufficiently strong for reliably braking rotation of the brake discs and the shaft for stopping movement of an elevator car that is coupled to the shaft may be applied to the brake discs even in situations in which one of the plungers is not movable due to a malfunction.

By employing an elevator brake according to an exemplary embodiment of the invention, hard stops of the elevator car that may be unpleasant or even dangerous for passengers within the elevator car may be prevented.

In the following, a number of optional features of an elevator brake according to exemplary embodiments of the invention are set out. These features may be realized in particular embodiments, alone or in combination with any of the other features, unless explicitly stated otherwise.

In an elevator brake according to an exemplary embodiment of the invention, the first movable plunger may be configured for frictionally engaging with the first brake disc, the second movable plunger may be configured for frictionally engaging with the second brake disc, and the third movable plunger may be configured for frictionally engaging with the first brake disc and/or with the second brake disc.

The elevator brake may further comprise a first stationary element and a second stationary element.

The first and second stationary elements may be fixed such as to not rotate with the shaft and not being movable in the axial direction with respect to the shaft.

In such a configuration, the first movable plunger may be configured for urging the first brake disc into frictional engagement with the first stationary element, thereby producing a braking force for braking the first brake disc and the shaft according to the frictional engagement.

The second movable plunger may be configured for urging the second brake disc into frictional engagement with the second stationary element, thereby producing a braking force for braking the second brake disc and the shaft according to the frictional engagement.

The third movable plunger may be configured for urging the first brake disc into frictional engagement with the first stationary element, or for urging the second brake disc into frictional engagement with the second stationary element, thereby producing a braking force for braking the shaft according to the frictional engagement.

Such a configuration allows engaging the elevator brake in three different modes, wherein in each mode two of the three plungers engage with the two brake discs. As different pair of plungers respectively comprising two of the three plungers may engage with the two brake discs in each of the three different modes. This enhances the redundancy and the safety of the elevator brake.

The first and second stationary elements may be spaced apart from each other along the axial direction. The first and second brake discs as well as the first, second and third plungers may be arranged in between the first and second stationary elements along the axial direction. The first and second brake discs may in particular be spaced apart from each other along the axial direction, and the third plunger may be arranged in between the first and second brake discs along the axial direction.

Such a configuration allows for a compact configuration of the elevator brake. It further allows the third plunger to selectively engage with the first stationary element and with the second stationary element, respectively.

Each of the at least two brake discs may comprise a first brake portion and a second brake portion. The first brake portion may be located in a larger radial distance from the shaft than the second brake portion. Such a configuration allows the different plungers to engage with different brake portions of each of the brake discs, allowing the different plungers to operate independently of each other

The first and second brake portions are formed integrally with each other. Forming the first and second brake portions integrally with each other may facilitate the production of the brake discs.

Alternatively, the first and second brake portions may be formed separately from each other for providing two brake portions that are completely independent of each other.

The first movable plunger may comprise a brake surface for engaging with the second brake portion of the first brake disc. The second movable plunger may comprise a brake surface for engaging with the second brake portion of the second brake disc.

At least one of the first and second brake portions of the brake discs, in particular the radially outer first brake portion, may comprise a brake lining attached to the respective one of the first and second brake discs such as not to be movable with respect to the brake disc in the axial direction.

One of the first and second brake portions of the brake discs, particularly the radially inner second brake portion, may comprise a brake lining attached to the respective one of the first and second brake discs such as to be movable with respect to the respective first or second brake disc in the axial direction.

Such a configuration allows the first and second brake portions to move in the axial direction with respect to each other. This may allow one of the first and second brake portions that is not urged into frictional engagement by the corresponding plunger not to engage with the corresponding plunger and/or the corresponding stationary element. As a result, wear on the respective brake portion may be reduced and the lifetime of the brake discs may be increased.

The third movable plunger may comprise a first brake surface for engaging with the first brake portion of the first brake disc and a second brake surface for engaging with the first brake portion of the second brake disc. The first and second brake surfaces of the third plunger may be arranged on opposite sides of the third plunger along the axial direction. The third plunger may in particular be configured for engaging the first brake surface with the first brake disc by moving the plunger into a first axial direction towards the first brake disc, and for engaging the second brake surface with the second brake disc by moving the plunger into an opposite second axial direction towards the second brake disc, respectively.

The one of the first and second brake portions that is movable with respect to the respective first or second brake disc may be provided on a carrier. The carrier may be mounted to the respective one of the first and second brake discs such as to be movable with respect to the respective first or second brake disc in the axial direction. The one of the first and second brake portions that is movable with respect to the respective first or second brake disc may in particular comprise a brake lining. The brake lining may be attached to the carrier of the respective one of the first and second brake discs.

Providing one of the first and second brake portions on a carrier that is movable with respect to the brake disc provides a convenient way of providing first and second brake portions that are movable along the axial direction with respect to each other.

The actuator may be provided at or in the third movable plunger, such as to be movable in the axial direction together with the third movable plunger. Providing the actuator at or in the third movable plunger allows for a compact configuration of the elevator brake. It further allows the actuator to efficiently act on the first and second plungers.

The first spring may be configured for exerting a spring force urging the first movable plunger away from the third movable plunger along the axial direction.

The second spring may be configured for exerting a spring force urging the second movable plunger away from to the third movable plunger along the axial direction.

The first and second springs may in particular be configured for urging the first and second movable plungers into opposite directions. Spring forces provided by the springs reliably allow urging the first and second movable plungers away from to the third movable plunger along the axial direction for engaging the first movable plunger and/or the second movable plunger into frictional engagement with one of the two brake discs, respectively.

The elevator brake may further comprise a longitudinal support member extending in the axial direction parallel to the shaft. The longitudinal support member may in particular extend between the first and second stationary elements. The longitudinal support member may be rigidly fixed to the first and second stationary elements so that it is not movable with respect to the first and second stationary elements.

At least one of the at least three movable plungers may be movably supported by the longitudinal support member in order to allow the at least one of the at least three movable plungers to move linearly in the axial direction.

The elevator brake may additionally comprise a further longitudinal support member extending in the axial direction and being supported by the third movable plunger. The further longitudinal support member may be configured for supporting the first and second movable plungers such as to be movable in axial directions with respect to the third movable plunger. The further longitudinal support member may be fixed by to the third movable plunger in a configuration in which it is not movable with respect to the third movable plunger in the axial direction.

### DRAWING DESCRIPTION

In the following, exemplary embodiments of the invention are described in more detail with respect to the enclosed figures:

FIG. 1 depicts a schematic view of an elevator system according to an exemplary embodiment of the invention.

FIG. 2 depicts a schematic view of an elevator brake according to an exemplary embodiment of the invention.

FIG. 3 shows the elevator brake in a released state.

FIG. 4 illustrated the elevator brake in a first engaged state.

FIG. 5 illustrated the elevator brake in a second engaged state.

### DETAILED DESCRIPTION

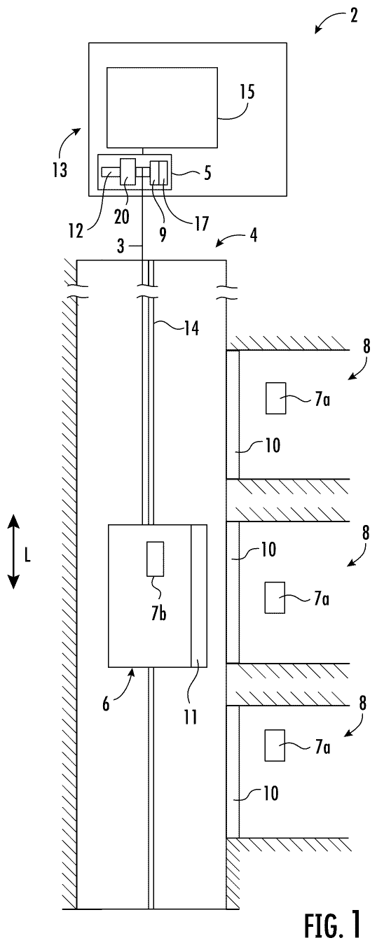

FIG. 1 schematically depicts an elevator system 2 according to an exemplary embodiment of the invention.

The elevator system 2 comprises a hoistway 4 extending in a longitudinal direction L between a plurality of landings 8 that are located on different floors. The elevator system 2 includes an elevator car 6 that is arranged within the hoistway 4 for being moved along the longitudinal direction L between the plurality of landings 8. The elevator car 6 is movable in particular along at least one elevator car guide member 14, such as at least one elevator car guide rail that is provided within the hoistway 4 and which extends along the longitudinal direction L.

The longitudinal direction L may be oriented in a vertical direction, as it is depicted in FIG. 1. In an alternative embodiment that is not depicted in the figures, the longitudinal direction L may be inclined with respect to the vertical direction.

Although only a single elevator car guide member 14 is visible in FIG. 1, the elevator system 2 may comprise a plurality of elevator car guide members 14.

Although only a single elevator car 6 is depicted in FIG. 1, exemplary embodiments of the invention may include elevator systems 2 comprising a plurality of elevator cars 6 moving in one or more hoistways 4.

The elevator car 6 is movably suspended by means of a tension member 3.

The tension member 3, for example a rope or belt, is coupled to an elevator drive system 5. The elevator drive system 5 comprises a motor 9 for rotatably driving a shaft 12 and a drive 17 that harnesses and controls the electrical energy supplied to the motor 9. The elevator drive system 5 is configured for driving the tension member 3 coupled to the shaft 12 in order to move the elevator car 6 within the hoistway 4 along the longitudinal direction L between the plurality of landings 8.

The elevator drive system 5 is further provided with at least one elevator brake 20 for braking rotation of the shaft 12 in order to allow stopping movement of the elevator car 6.

The elevator system 2 may further include an elevator counterweight, which is not depicted in FIG. 1. The elevator counterweight may be attached to the tension member 3 opposite to the elevator car 6 and configured for moving concurrently and in opposite direction with respect to the elevator car 6 along at least one elevator counterweight guide member, which is also not shown in FIG. 1.

Exemplary embodiments of the invention may be employed in elevator systems 2 comprising a counterweight and in elevator systems 2 that do not comprise an elevator counterweight.

The tension member 3 may be a rope, e.g. a steel cord, or a belt. The tension member 3 may be uncoated. Alternatively, the tension member 3 may be coated with a coating, e.g. with a coating having the form of a polymer jacket. In a particular embodiment, the tension member 3 may be a belt comprising a plurality polymer coated steel cords (not shown). The elevator system 2 may have a traction drive including a traction sheave for driving the tension member 3.

The exemplary embodiment shown in FIG. 1 uses a 1:1 roping for suspending the elevator car 6. The skilled person, however, easily understands that the type of the roping is not essential for the invention and that different kinds of roping, e.g. a 2:1 roping or a 4:1 roping may be used as well.

A landing door 10 is provided at each of the landings 8. The elevator car 6 is provided with a corresponding elevator car door 11 for allowing passengers to transfer between a landing 8 and the interior of the elevator car 6, when the elevator car 6 is positioned at the respective landing 8.

For moving the elevator car 6 along the hoistway 4 between the different landings 8, the elevator drive system 5 may be controlled by a controller 15 of the elevator system 2.

The elevator system 2 may comprise a machine room 13 housing the elevator drive system 5 and the controller 15. Alternatively, the elevator system 2 may be a machine room-less elevator system 2.

Input to the controller 15 may be provided via landing control panels 7a that are provided on every landing 8, in particular in the vicinity of the landing doors 10, and/or via an elevator car control panel 7b that is provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6, since the elevator system 2 is fully controlled by the commands input via the landing control panels 7a.

The landing control panels 7a and the elevator car control panel 7b may be connected to the controller 15 by means of electrical wiring that are not shown in FIG. 1, in particular by an electric bus, or by means of wireless data connections.

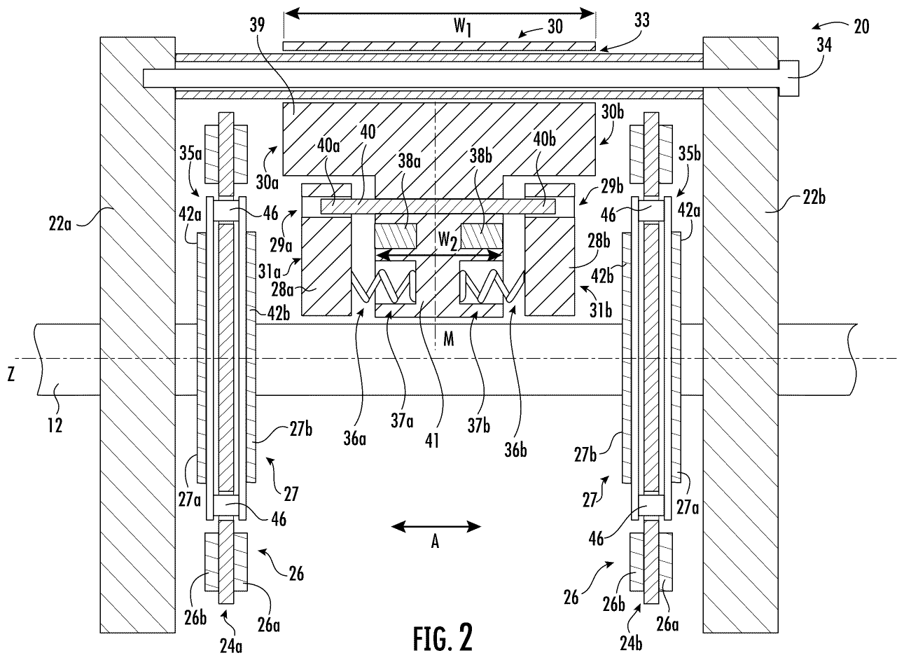

FIG. 2 depicts a schematic view of an elevator brake 20 according to an exemplary embodiment of the invention.

The elevator brake 20 comprises, in the exemplary orientation depicted in FIG. 2 from left to right: A first stationary element 22a, a first brake disc 24a, three movable plungers 28a, 28b, 30, a second brake disc 24b and a second stationary element 22b.

The two brake discs 24a, 24b are non-rotatably coupled to the shaft 12. The shaft 12 extends in an axial direction A along an axis of rotation Z. The two brake discs 24a, 24b may be movable along the shaft 12 in the axial direction A.

Each of the two brake discs 24a, 24b comprises a first brake portion 26 and a second brake portion 27, respectively. The first brake portions 26 are located in a larger radial distance from the shaft 12 than the second brake portions 27.

The first and second brake portions 26, 27 may be formed integrally with each other. Alternatively, the first and second brake portions 26, 27 may be formed separately from each other, as it is depicted in FIG. 2.

The first and second brake portions 26, 27 may in particular be provided as two coaxial brake portions rings that are centered at the axis of rotation Z. The second brake portions ring may be arranged within the first brake portion ring.

The first brake portion 26 may comprise a first brake lining 26a, 26b that is firmly attached to the brake disc 24a, 24b such as not to be movable with respect to the brake disc 24a, 24b. The first brake lining 26a, 26b may in particular include two first brake lining portions 26a, 26b that are attached to opposite sides of the respective brake disc 24a, 24b.

The second brake portion 27 may comprise a second brake lining 27a, 27b that is mounted to the brake discs 24a, 24b in a configuration in which it is movable with respect to the brake disc 24a, 24b along the axial direction A.

The second brake lining 27a, 27b may in particular include two brake lining portions 27a, 27b that are provided on and attached to opposite sides of the respective brake disc 24a, 24b.

The second brake lining 27a, 27b may be attached to a carrier 35a, 35b mounted to the respective one of the first and second brake discs 24a, 24b, such as to be movable with respect to the respective first or second brake disc 24a, 24b in the axial direction A.

Each carrier 35a, 35b may comprise two support plates 42a, 42b. Each of the two support plates 42a, 42b of each carrier 35a, 35b may support one of the two brake lining portions 27a, 27b, respectively. The two support plates 42a, 42b of each carrier 35a, 35b may be coupled with each other by a plurality of connectors 46. The connectors 46 may extend through the respective brake disc 24a, 24 and support the two support plates 42a, 42b on the respective brake disc 24a, 24b such as to be movable along the axial direction A.

A longitudinal support member 34 extends between the first and second stationary elements 22a, 22b parallel to the shaft 12. The longitudinal support member 34 is rigidly fixed to the first and second stationary elements 22a, 22b so that it is not movable with respect to the first and second stationary elements 22a, 22b.

The three plungers 28a, 28b, 30 arranged between the first and second brake discs 24a, 24b may include a first plunger 28a, a second plunger 28b and a third plunger 30.

The third plunger 30 is formed symmetrically with respect to a mirror plane M extending perpendicularly to the axial direction A.

In the sectional view depicted in FIG. 3, the third plunger 30 has the shape of a “T”, comprising a broad first portion 39 and a narrow second portion 41. The first portion 39 has a first width w₁ along the axial direction A. The second portion 41 has a second width w₂ in the axial direction that is shorter than the first width w₁.

The first width w₁ may, for example, be in the range of between 50 mm and 100 mm. The second width w₂ may, for example, be in the range of between 30 mm and 70 mm.

The third plunger 30 is supported by the longitudinal support member 34 in a configuration in which the third plunger 30 is movable along the longitudinal support member 34 in the axial direction A.

In the exemplary embodiment depicted in FIG. 2, an opening 33 extending in the axial direction A is formed in the first portion 39 of the third plunger 30. The longitudinal support member 34 extends through said opening 33. As a result, the third plunger 30 is able to slide along the longitudinal support member 34 in the axial direction A.

A first end surface of the first portion 39 of the third plunger 30 provides a first brake surface 30a for frictionally engaging with the first brake portion 26 of the first brake disc 24a. A second end surface of the first portion 39 of the third plunger provides a second brake surface 30b for frictionally engaging with the first brake portion 26 of the second brake disc 24b.

The elevator brake 20 additionally comprises a further (second) longitudinal support member 40. The further longitudinal support member 40 extends in the axial direction A and is supported by the third plunger 30, in particular by the second portion 41 of the third plunger 30.

The further longitudinal support member 40 is fixed to the third plunger 30 in a configuration in which it is not movable with respect to the third plunger 30 along the axial direction A.

The further longitudinal support member 40 supports the first plunger 28a and the second plunger 28b in a configuration that allows the first and second plungers 28a, 28b to move along the axial direction A with respect to the third plunger 30.

The further longitudinal support member 40 comprises in particular a first end portion 40a facing the first brake disc 24a and supporting the first plunger 28a, and an opposing second end portion 40b supporting the second plunger 28b.

The first plunger 28a comprises a first opening 29a extending in the axial direction A. The second plunger 28b comprises a second opening 29b extending in the axial direction A, too. The first and second end portions 40a, 40b of the further longitudinal support member 40 extend into the first and second openings 29a, 29b, respectively, supporting the first and second plungers 28a, 28b and allowing the first and second plungers 28a, 28b to slide along the further longitudinal support member 40 in the axial direction A.

The first plunger 28a comprises a brake surface 31a facing the first brake disc 24a and configured for engaging with the second brake portion 27 of the first brake disc 24a.

The second plunger 28b comprises a brake surface 31b facing the second brake disc 24b and configured for engaging with the second brake portion 27 of the second brake disc 24b.

A first spring 36a is provided between the first plunger 28a and the third plunger 30. The first spring 36a is configured for urging the first plunger 28a away from the third plunger 30 towards the first brake disc 24a, in particular into frictional engagement with the second brake portion 27 of the first brake disc 24a.

The first spring 36a may be partially arranged within a first recess 37a formed in the surface of the second portion 41 of the third plunger 30 facing the first plunger 28a, as it is depicted in FIG. 2. Additionally or alternatively, the first spring 36a may be partially arranged within a similar recess (not shown) that may be formed in the first plunger 28a.

In order to allow for releasing the elevator brake 20, the third plunger 30 further comprises a first solenoid 38a that is associated with the first spring 36a and configured for producing a magnetic counterforce directed against the spring force applied by the first spring 36a such as to pull the first plunger 28a along the axial direction A away from the first brake disc 24a towards the second portion 41 of the third plunger 30.

A second spring 36b is provided between the second plunger 28b and the third plunger 30. The second spring 36b is configured for urging the second plunger 28b away from the third plunger 30 towards the second brake disc 24b, in particular into frictional engagement with the second brake portion 27 of the second brake disc 24b.

The second spring 36b may be partially arranged within a second recess 37b formed in the surface of the second portion 41 of the third plunger 30 facing the second plunger 28b, as it is depicted in FIG. 2. Additionally or alternatively, the second spring 36b may be partially arranged within a similar recess (not shown) that may be formed in the second plunger 28b.

In order to allow for releasing the elevator brake 20, the third plunger 30 further comprises a second solenoid 38b associated with the second spring 36b and configured for producing a magnetic counterforce that is directed against the spring force applied by the second spring 36b such as to pull the second plunger 28b along the axial direction A away from the second brake disc 24b towards the second portion 41 of the third plunger 30.

For releasing the elevator brake 20 depicted in FIG. 2, both solenoids 38a, 38b are activated for pulling the first and second plungers 28a, 28b against the spring forces applied by the first and second springs 36a, 36b towards the second portion 41 of the third plunger 30 and away from the first and second brake discs 24a, 24b, respectively.

In the released state of the elevator brake 20 none the brake surfaces 30a, 30b, 31a, 30b of the three plungers 28a, 28b, 30 is in frictional engagement with any of the brake discs 24a, 24b. In consequence, both brake discs 24a, 24b and the shaft 12 are able to rotate freely around the axis of rotation Z.

The elevator brake 20 depicted in FIG. 2 comprises three different engaged states. Each of said three different engaged states is schematically illustrated in one of FIGS. 3 to 5, respectively.

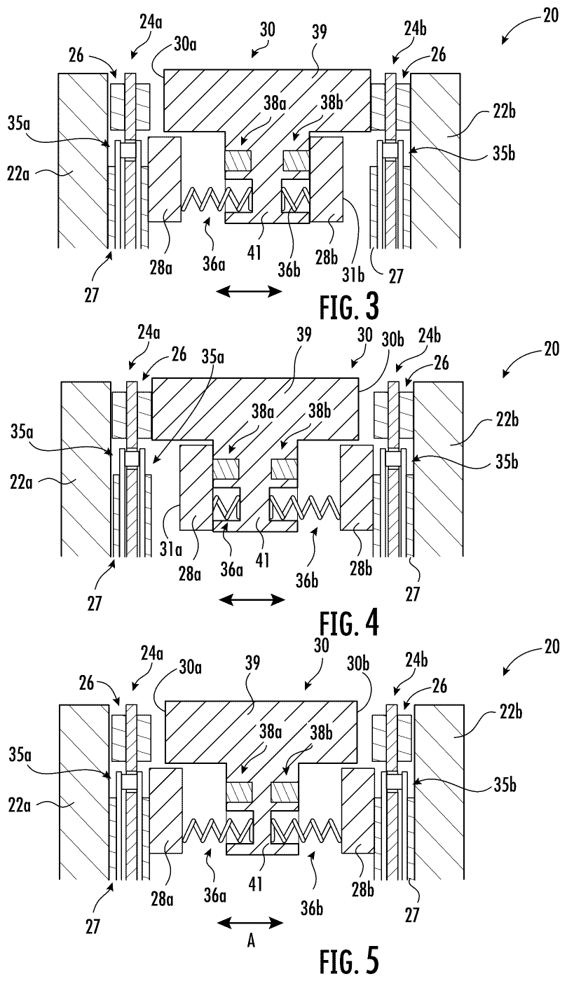

In particular in North America, the engaged state depicted in FIG. 3 may be used for stopping movement of the elevator car in normal operation. The engaged state depicted in FIG. 4 may be used for emergency stopping, and the engaged state depicted in FIG. 5 may occur when the system is shut down due to a loss of electric power.

It is possible that the engaged state depicted in FIG. 5 is used for normal stopping the elevator car.

In a first engaged state, which is schematically depicted in FIG. 3, the first solenoid 38a is deactivated. This allows the first spring 36a to urge the first plunger 28a along the axial direction A away from the second portion 41 of the third plunger 30 towards the first brake disc 24a, causing the brake surface 31a of the first plunger 28a to engage with the second brake portion 27 of the first brake disc 24a.

In the first engaged state, the second plunger 28b did not move with respect to the third plunger 30, for example because the second solenoid 38b has not been deactivated or because the second plunger 38b sticks to the second portion 41 of the third plunger 30 and/or the second spring 36b is not able to move the second plunger away from the second portion 41 of the third plunger 30.

The third plunger 30 is, however, urged by the force provided by the first spring 36a away from the first brake disc 24a towards the second brake disc 24b, causing the second brake surface 30b of the third plunger 30 formed at the end face of the first portion 39 of the third plunger 30 facing the second brake disc 24b into frictional engagement with the first brake portion 26 of the second brake disc 24b.

In consequence, the first brake disc 24a, in particular the second brake portion 27 of the first brake disc 24a, is sandwiched and squeezed between the first stationary element 22a and the first plunger 28a due to the elastic force provided by the first spring 36a. Similarly, the second brake disc 24b, in particular the first brake portion 26 of the second brake disc 24b, is sandwiched and squeezed between the second stationary element 22b and the third plunger 30.

Frictional engagement between the brake discs 24a, 24b and a respective one of the first and second stationary elements 22a, 22b and a respective one of the first and third plungers 28a, 30 brakes rotation of the first and second brake discs 24a, 24b as well as rotation of the shaft 12 to which the first and second brake discs 24a, 24b are mounted.

Since the second brake portions 27 of the first and second brake discs 24a, 24b are movable with respect to the first brake portions 26 along the axial direction, the first brake portion 26 of the first brake disc 24a is neither in frictional engagement with the first brake surface 30a of the third plunger 30, nor is it in frictional engagement with the first stationary element 22a. Similarly, the second brake portion 27 of the second brake disc 24b is neither in frictional engagement with the brake surface 31b of the second plunger 28b, nor is it in frictional engagement with the second stationary element 22b.

As a result, the brake linings 26a, 26b on the first brake portion 26 of the first brake disc 24a and the brake linings 27a, 27b on the second brake portion 27 of the second brake disc 24b are protected from wear caused by the rotation of the brake disc 24a, 24b. This may extend the lifetime of the elevator brake discs 24a, 24b.

A second engaged state is schematically depicted in FIG. 4. In the second engaged state the second solenoid 38b is deactivated. This allows the second spring 36b to urge the second plunger 28b along the axial direction A away from the second portion 41 of the third plunger 30 towards the second brake disc 24b, causing the brake surface 31b of the second plunger 28b into frictional engagement with the second brake portion 27 of the second brake disc 24b.

In the second engaged state, the first plunger 28a did not move with respect to the third plunger 30, for example because the first solenoid 38a has not been deactivated or because the first plunger 38a sticks to the second portion 41 of the third plunger 30 and/or the first spring 36b is not able to move the second plunger 28b away from the second portion 41 of the third plunger 30.

The third plunger 30 is, however, urged by the second spring 36b away from the second brake disc 24b towards the first brake disc 24a. This causes the first brake surface 30a of the third plunger 30 provided at the end face of the first portion 39 of the third plunger 30 facing the first brake disc 24a to engage with the first brake portion 26 of the first brake disc 24a.

In consequence, due to the elastic force provided by the second spring 36b, the second brake disc 24b, in particular the second brake portion 27 of the second brake disc 24b, is sandwiched and squeezed between the second stationary element 22b and the second plunger 28b. Similarly, the first brake disc 24a, in particular the first brake portion 26 of the first brake disc 24a, is sandwiched and squeezed between the first stationary element 22a and the third plunger 30.

Frictional engagement of the brake discs 24a, 24b with a respective one of the first and second stationary elements 22a, 22b and a respective one of the second and third plungers 28b, 30 brakes rotation of the first and second brake discs 24a, 24b and rotation of the shaft 12 to which the first and second brake discs 24a, 24b are mounted.

Since the second brake portions 27 of the first and second brake discs 24a, 24b are movable with respect to the first brake portions 26 along the axial direction A, the second brake portion 27 of the first brake disc 24a is neither in frictional engagement with the brake surface 31a of the first plunger 28a, nor is it in frictional engagement with the first stationary element 22a. Similarly, the first brake portion 26 of the second brake disc 24b is neither in frictional engagement neither with the brake surface 30b of the third plunger 30b, nor is it in frictional engagement with the second stationary element 22b.

In consequence, the brake linings 26a, 26b, 27a, 27b of the second brake portion 27 of the first brake disc 24a and of the first brake portion 26 of the second brake disc 24b are protected from wear caused by the rotation of the discs. This may extend the lifetime of the elevator brake discs 24a, 24b.

A third engaged state of the elevator brake 20 is schematically illustrated in FIG. 5.

In the third engaged state both solenoids 38a, 38b are deactivated. In consequence, the first and second plungers 28a, 28b are both pushed away from the second portion 41 of the third plunger 30 towards the brake discs 24a, 24b by the first and second springs 36a, 36b, respectively.

The first and second plungers 28a, 28b are in particular pushed into opposite directions along the axial direction A: The first plunger 28a is pushed towards the first brake disc 24a and the second plunger 28b is pushed towards the second brake disc 24b. As a result, the brake surface 31a of the first plunger 28a frictionally engages with the second brake portion 27 of the first brake disc 24b and the brake surface 31b of the first plunger 28b frictionally engages with the second brake portion 27 of the second brake disc 24b, respectively.

In consequence, due to the elastic forces provided by the first and second springs 36a, 36b, the first brake disc 24a, in particular the second brake portion 27 of the first brake disc 24a, is sandwiched and squeezed between the first stationary element 22a and the first plunger 28a and the second brake disc 24b, in particular the second brake portion 27 of the second brake disc 24b, is sandwiched and squeezed between the second plunger 28b and the second stationary element 22b.

The frictional engagement of each of the brake discs 24a, 24b with a respective one of the first and second stationary elements 22a, 22b and with a respective one of the first and second plungers 28a, 28b brakes rotation of the first and second brake discs 24a, 24b and rotation of the shaft 12 to which the first and second brake discs 24a, 24b are mounted.

Since in an elevator brake 20 according to an exemplary embodiment of the invention, the first and second springs 36a, 36b are coupled serially with each other along the axial direction A, the total braking force acting on the shaft 12 is not doubled when both plungers 28a, 28b are simultaneously activated and urged against the two brake discs 24a, 24b by the two springs 36a, 36a. In consequence, an unpleasant and potentially dangerous hard stop of the movement of an elevator car 6 that is coupled to the shaft 12 may be reliably prevented.

In the third engaged state depicted in FIG. 5, the third plunger 30 is not urged against any of the first and second brake discs 24a, 24b, respectively.

Since the second brake portions 27 of the first and second brake discs 24a, 24b are movable with respect to the first brake portions 26 along the axial direction A, neither the third plunger 30 nor any of the first and second stationary elements 22a, 22b are in frictional engagement with any of the first brake portions 26 of the first and second brake discs 24a, 24b.

In consequence, the brake linings 26a, 26b of the first brake portions 26 of the first and second brake discs 24a, 24b are protected from wear caused by the rotation of the brake discs 24a, 24b. This may extend the lifetime of the brake discs 24a, 24b.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention shall not be limited to the particular embodiment disclosed, but that the invention includes all embodiments falling within the scope of the dependent claims.

### REFERENCES

2 elevator system
3 tension member
4 hoistway
5 elevator drive system
6 elevator car
7a landing control panel
7b elevator car control panel
8 landing
9 motor
10 landing door
11 elevator car door
12 shaft
13 machine room
14 elevator car guide member
15 controller
17 drive
20 elevator brake
22a first stationary element
22b second stationary element
24a first brake disc
24b second brake disc
26 first brake portion
26a, 26b first brake lining portions
27 second brake portion
27a, 27b second brake lining portions
28a first plunger
29a first opening
28b second plunger
29b second opening
30 third plunger
30a first brake surface
30b second brake surface
31a brake surface of the first plunger
31b brake surface of the second plunger
33 opening
34 longitudinal support member
35a first carrier
35b second carrier
36a first spring
36b second spring
37a first recess
37b second recess
38a first solenoid
38b second solenoid
39 first portion of the third plunger
40 further longitudinal support member
40a first end portion of the support member
40b second end portion of the support member
41 second portion of the support member
42a first support plate
42b second support plate
46 connectors

What is claimed is:

1. Elevator brake (20) for braking rotation of a shaft (12) in an elevator drive system (5), the shaft (12) extending in an axial direction (A) and being rotatable around an axis of rotation (Z), the elevator brake (20) comprising:
at least two brake discs (24a, 24b) including a first brake disc (24a) and a second brake disc (24b), wherein the at least two brake discs (24a, 24b) are mounted to the shaft (12) such as to rotate concurrently with the shaft (12);
at least three movable plungers (28a, 28b, 30) including a first movable plunger (28a), a second movable plunger (28b) and a third movable plunger (30) (30), wherein the at least three movable plungers (28a, 28b, 30) are movable along the axial direction (A) for selectively engaging the elevator brake (20) or releasing the elevator brake (20); and
an actuator comprising:
at least two springs (26a, 36b) including a first spring (36a) and a second spring (36b), wherein each of the at least two springs (26a, 36b) is configured for applying a spring force to at least two of the at least three movable plungers (28a, 28b, 30) for urging the at least one movable plunger (28a, 28b, 30) towards at least one of the brake discs (24a, 24b) for engaging the elevator brake (20); and
at least two solenoids (38a, 38b), wherein each solenoid is associated with a respective one of the at least two springs (26a, 36b) and configured for producing a counterforce directed against the respective spring force applied by the respectively associated spring (26a, 36b) such as to urge the respective at least one movable plunger (28a, 28b, 30) in the axial direction (A) away from the respective brake disc (24a, 24b);
wherein the at least two springs (26a, 36b) are arranged in series to each other along the axial direction (A).

2. Elevator brake (20) according to claim 1,
wherein the first movable plunger (28a) is configured for frictionally engaging with the first brake disc (24a);
wherein the second movable plunger (28b) is configured for frictionally engaging with the second brake disc (24b); and
wherein the third movable plunger (30) is configured for frictionally engaging with the first brake disc (24a) and/or with the second brake disc (24b).

3. Elevator brake (20) according to claim 1, further comprising:
a first stationary element (22a) that is not rotating with the shaft (12) and that is not movable in the axial direction (A) with respect to the shaft (12); and
a second stationary element (22b) that is not rotating with the shaft (12) and that is not movable in the axial direction (A) with respect to the shaft (12);
wherein the first movable plunger (28a) is configured for urging the first brake disc (24a) into frictional engagement with the first stationary element (22a), thereby producing a braking force for braking the first brake disc (24a) and the shaft (12) according to the frictional engagement; and/or
wherein the second movable plunger (28b) is configured for urging the second brake disc (24b) into frictional engagement with the second stationary element (22b), thereby producing a braking force for braking the second brake disc (24b) and the shaft (12) according to the frictional engagement; and/or
wherein the third movable plunger (30) is configured for urging the first brake disc (24a) into frictional engagement with the first stationary element (22a), or for urging the second brake disc (24b) into frictional engagement with the second stationary element (22b), thereby producing a braking force for braking the shaft (12) according to the frictional engagement.

4. Elevator brake (20) according to claim 3, wherein the first and second stationary elements (22a, 22b) are spaced apart from each other along the axial direction (A), and wherein the first and second brake discs (24a, 24b) as well as the first, second and third movable plungers (28a, 28b, 30) are arranged in between the first and second stationary elements (22a, 22b) along the axial direction (A);
wherein the first and second brake discs (24a, 24b) are in particular spaced apart from each other along the axial direction (A), and wherein the third movable plunger (30) is arranged in between the first and second brake discs (24a, 24b) along the axial direction (A).

5. Elevator brake (20) according to claim 1, wherein each of the at least two brake discs (24a, 24b) comprises a first brake portion (26) and a second brake portion (27), respectively, wherein the first brake portion (26) is in particular located in a larger radial distance from the shaft (12) than the second brake portion (27).

6. Elevator brake (20) according to claim 5,
wherein the first and second brake portions (26, 27) are formed integrally with each other, or
wherein the first and second brake portions (26, 27) are formed separately from each other.

7. Elevator brake (20) according to claim 5,
wherein the first movable plunger (28a) comprises a brake surface (31a) for engaging with the second brake portion (27) of the first brake disc (24a); and/or
wherein the second movable plunger (28b) comprises a brake surface (31b) for engaging with the second brake portion (27) of the second brake disc (24b); and/or
wherein the third movable plunger (30) comprises a first brake surface (30a) for engaging with the first brake portion (26) of the first brake disc (24a) and a second brake surface (30b) for engaging with the first brake portion (26) of the second brake disc (24b).

8. Elevator brake (20) according to claim 5,
wherein at least one of the first and second brake portions (26, 27), particularly the radially outer first brake portion (26), comprises a brake lining (26a, 26b, 27a, 27b) attached to the respective one of the first and second brake discs (24a, 24b) such as not to be movable with respect to the respective brake disc (24a, 24b) in the axial direction (A); and/or
wherein one of the first and second brake portions (26, 27), particularly the radially inner second brake portion (27), comprises a brake lining (26a, 26b, 27a, 27b) attached to the respective one of the first and second brake discs (24a, 24b) such as to be movable with respect to the respective brake disc (24a, 24b) in the axial direction (A).

9. Elevator brake (20) according to claim 8,
wherein the one of the first and second brake portions (26, 27) that is movable with respect to the respective first or second brake disc (24a, 24b) is provided on a carrier (35a, 35b) mounted to the respective one of the first and second brake discs (24a, 24b) such as to be movable with respect to the respective first or second brake disc (24a, 24b) in the axial direction (A);
wherein the one of the first and second brake portions (26, 27) that is movable with respect to the respective first or second brake disc (24a, 24b) comprises in particular a brake lining (26a, 26b, 27a, 27b) that is attached to the carrier (35a, 35b) of the respective one of the first and second brake discs (24a, 24b).

10. Elevator brake (20) according to claim 1, wherein the actuator is provided at or in the third movable plunger (30) such as to be movable in the axial direction (A) together with the third movable plunger (30).

11. Elevator brake (20) according to claim 1,
wherein the first spring (36a) is configured for exerting a spring force urging the first movable plunger (28a) away from to the third movable plunger (30) along the axial direction (A), and
wherein the second spring (36b) is configured to exert a spring force urging the second movable plunger (28b) away from to the third movable plunger (30) along the axial direction (A);
wherein the first and second springs (26a, 36b) are in particular configured for urging the first and second movable plungers (28a, 28b) into opposite directions.

12. Elevator brake (20) according to claim 1, further comprising a longitudinal support member (34) extending parallel to the shaft (12),
wherein at least one of the at least three movable plungers (28a, 28b, 30) is movably supported by the longitudinal support member (34);
wherein in particular the third movable plunger (30) is movably supported by the longitudinal support member (34).

13. Elevator brake (20) according to claim 1,
further comprising a further longitudinal support member (40) supported by the third movable plunger (30) and extending in the axial direction (A);
wherein the further longitudinal support member (40) is configured for supporting the first and second movable plungers (28a, 28b) such as to be movable in axial directions (A) with respect to the third movable plunger (30);
wherein the further longitudinal support member (40) is in particular fixed by to the third movable plunger (30) so that it is not movable with respect to the third movable plunger (30) in the axial direction (A).

14. Elevator drive system (5) comprising a shaft (12), a motor (9) for rotating the shaft (12) and an elevator brake (20) according to claim 1 for braking rotation of the shaft (12).

15. Elevator system (2) comprising:
an elevator car (6) that is movable in a hoistway (4) between a plurality of landings and an elevator drive system (5) according to claim 14 that is configured for moving the elevator car (6) along the hoistway (4).
